(19) United States
(12) Patent Application Publication
(10) Pub. No.: US 2007/0092829 A1
(43) Pub. Date: Apr. 26, 2007

(54) Photosensitive coating for enhancing a contrast of a photolithographic exposure

(76) Inventors: Christoph Noelscher, Nuernberg (DE); Klaus Elian, Bubenreuth (DE)

Correspondence Address: SLATER & MATSIL LLP, 17950 PRESTON ROAD, SUITE 1000, DALLAS, TX, 75252, US

(21) Appl. No.: 11/256,677

(22) Filed: Oct. 21, 2005

(51) Int. Cl. G03C 1/00

(52) U.S. Cl. 430/270.1

(57) ABSTRACT

A photosensitive coating material for enhancing a contrast of a photolithographic exposure of a resist film formed on a substrate, including a base polymer, a solvent for facilitating deposition of the photosensitive coating material upon a surface adjacent to said resist film to form a film thereupon, an alkaline additive suited to diffuse into the adjacent resist for reducing or neutralizing an acid concentration formed locally therein, a photoactive component arranged to reduce or neutralize a concentration of the alkaline additives in portions of the photosensitive coating, which are exposed with optical light, UV- or X-ray radiation, electrons, charged particles, ion projection lithography.

### TECHNICAL FIELD

The invention relates to a photosensitive coating for enhancing a contrast of a photolithographic exposure of a resist formed on a substrate. The invention further relates to multilayer resists.

### BACKGROUND

In the field of semiconductor manufacturing, integrated circuits are formed by exposing semiconductor wafers layer by layer with each a pattern formed on respective masks of a dedicated set. The wafers are thereby covered with a photosensitive resist, which is coated on the layer currently to be exposed. With the ongoing decrease of feature sizes, so-called lithographic enhancement techniques are utilized in order to increase the resolution and depth of focus with respect to an exposure. These techniques relate to improvements in the optical systems (exposure apparatus), types of masks (phase shift masks, trimming masks, etc.) or the resists.

One phenomenon that often occurs, when features are printed onto a wafer having a width near the resolution limit of the optical system, is the formation of side lobes near the main feature in the resist on the substrate. These side lobes correspond to side maxima of an intensity distribution, which are due to interference effects.

The side maxima are disadvantageously aggravated if the optical system, in particular the lenses, suffer from aberration. The intensity of such a side maximum may reach a threshold value, for which the resist is effectively exposed. The corresponding resist portions will thus be removed in a subsequent development step. An undesired formation of a feature in an underlying layer after performing an etch step may result.

The formation of undesired features also occurs when assist features having sub-resolution size affect a local intensity maximum, which exceeds a threshold value of the resist. This may similarly be due to an optical aberration of the lens system.

Lithographic enhancement techniques further deal with a strong need for enhancing the optical contrast of an exposure. The optical contrast is defined as the difference between the maximum and minimum intensity of an imaged pattern, divided by the sum of both intensities. Analogously, the acid contrast is defined by the difference of maximum and minimum acid concentrations divided by their sum.

In Leuschner, R. and Pawlowski, G.: “Photolithography, Handbook of Semiconductor Technology Processing of Semiconductors”, Materials Science and Technology, Vol. 16, Wiley-VCH, 1998 is disclosed a method of enhancing the contrast by forming a bi-layer resist, wherein the uppermost layer serves as the contrast enhancing layer. This layer has a strong absorption until it becomes transparent by bleaching during the exposure when a sufficient dosis is reached.

Regions of this contrast-enhancing layer (CEL), which are not exposed are thus still absorptive and the underlying resist film thus receives a reduced amount of exposure light beneath these regions. As a consequence, the sidewall slopes of the lines formed in the resist after development are considerably steepened. However, this approach involves problems when using chemically amplified resists (CAR) as the underlying resist, since CAR resists allow only moderate doses in an exposure.

An alternative method of improving the contrast is proposed in Tsujita, K. and Mita, I., “Improvement of a deteriorated Resolution caused by Polarisation Phenomenon with TARC Process”, Optical Microlithography XVII, Proceedings of SPIE Vol. 5377, pp. 80-90, 2004. There, a top antireflective coating (TARC) is disclosed, which enhances contrast by reducing the polarization effects, which would otherwise deteriorate the exposure quality.

A further method for increasing the contrast and reducing the occurrence of side lobes is disclosed in Jung et al., “Quencher Gradient Resist Process for Low K Process”, Advances in Resist Technology and Processing XXI, Proceedings of SPIE, Vol. 5376, pp. 63-70, 2004. According to this approach, a resist top coating contains a polymer matrix with alkaline additives. During a post-exposure bake (PEB) the alkaline additives diffuse into the underlying resist film. Therein, an acid generated during an exposure is neutralized, or quenched. This quenching process yields an overall reduction of the acid concentration near the surface of the resist. As a result the acid concentration in the vicinity of a side lobe falls below the threshold value thus leading to a non-printing of the side lobe.

The main structure formed on the wafer, which corresponds to the pattern on the mask, is also slightly affected at its margins. Consequently, the width of a structure resulting from an exposure is somewhat smaller than if no top coating had been used upon the resist. Further, as the alkaline outdiffusion from the top coating into the resist film only affects a surface portion of the resist film, the profile of a resist web develops a T-form, i.e., an overhanging profile due to the more ineffective exposure near the resist surface.

### SUMMARY OF THE INVENTION

In one aspect, the invention improves the contrast achievable during an exposure, a subsequent bake and a development in a resist. In a further aspect, a reduction in the occurrences of side lobes in a photolithographic process step can be achieved. In yet a aspect, the invention improves the resolution and the depth of focus with regard to photolithographic exposure.

In a first embodiment, a photosensitive coating material is provided for forming a contrast enhancing layer (CEL) with respect to a resist film, which is formed on a substrate. The coating material includes a base polymer. A solvent for facilitating deposition of the photosensitive coating material is disposed upon a surface adjacent to the resist to form a film thereupon. An alkaline additive is suited to diffuse into the adjacent resist for reducing or neutralizing an acid concentration formed locally therein. A photoactive component is arranged to reduce or neutralize a concentration of the alkaline additives in portions of the photosensitive coating that are exposed with optical light, UV- or X-ray radiation, electrons, charged particles, ion projection lithography.

In another embodiment, a multilayer coating is disposed on a substrate prior to photolithographic exposure. The coating includes at least one photosensitive resist film, and a contrast enhancing layer (CEL), which is deposited upon the photosensitive resist film. The CEL includes a base polymer, an alkaline additive that is suited to diffuse into the adjacent resist for locally reducing or neutralizing an acid concentration formed therein, and a photoactive component arranged to reduce or neutralize a concentration of the alkaline additives in portions of the photosensitive coating, which are exposed with the optical light, UV- or X-ray radiation, electrons, charged particles, ion projection lithography.

The resist film may include a further base polymer having an acid sensitive group, and a photolytic acid generator for generating an acid under exposure with optical light, UV- or X-ray radiation, electrons, charged particles, ion projection lithography. The acid is arranged to release the acid sensitive group for altering the polarity of the first base polymer in order to provide a selective removal of portions, comprising altered first base polymers with respect to a developer solution.

According to a further aspect, a substrate is provided having a surface that comprises the multilayer according to the previous aspect. Methods of manufacturing the photosensitive coating material and of exposing a semiconductor wafer using this material are also provided in the appended claims.

The photosensitive coating material as described according to aspects and embodiments of the invention is also referred to throughout this document as a “chemically amplified contrast enhancement layer”, CCEL, or simply as a photosensitive CEL. The CCEL is used as a top coat to be formed upon a resist film.

Contrast enhancing layers, and the “CCEL” as proposed herein, have the implicit feature that these are completely soluble in exposed and unexposed areas with respect to an agence (developer or another medium, for example a removal solvent of a protective coating in immersion lithography), which distinguishes them from a resist. The latter may be formed into an etch mask, which is effected by making portions of the resist film selectively soluble with respect to a developer due to an exposure. The feature of being photosensitive by means of the photoactive component according to embodiments of the invention, however, does not imply that a selective solubility is achieved in different portions of the coating.

It is important that alkaline additives may diffuse out of the photosensitive coating film into the photosensitive resist film within unexposed and low exposed portions. According to one embodiment of the invention, acids may be generated by a photoactive component to reduce the concentration of alkaline additives within the coating film (CCEL) and to accomplish acid diffusion into the underlying resist film within exposed portions.

With regard to the term “alkaline” as used herein, it is understood that material such as water having a bigger pkₐ-value as acids is also included, as it is similarly suited to achieve the effects of the invention as described below.

With regard to the term “substrate”, it is understood herein, that the substrate may comprise a base body of a specific material such as silicon, glass or quartz, and further one or more layers deposited on top of the surface of this body. In some of the embodiments described later herein, the body may also explicitly be referred to as the substrate.

It is preferred that both layers are formed adjacent to each other, i.e., they are in direct contact with each other. Further, as side lobes frequently develop near the upper surface of the resist film and the diffusion length of the acid and alkaline molecules is too short to completely penetrate the resist film, the use of the photosensitive contrast-enhancing coating as a top coat is also preferred. In this case, the diffusing molecules may easily reach the region, where side lobes may arise.

The photosensitive coating comprises a photoactive component. This component serves to reduce or neutralize the concentration of alkaline additives under exposure, i.e., within exposed regions as opposed to unexposed regions in the coating film/CCEL. Two aspects, which may be combined, relate to embodiments of the photoactive component. In one embodiment, the photoactive component is a photolytic acid generator, in another embodiment, the photoactive component is provided by the alkaline additive itself, which is then photodecomposable.

The outdiffusion of alkaline molecules—or optionally in the case of the photolytic acid generator: of the acid molecules within exposed regions—primarily occurs during a post-exposure bake step. The photosensitive coating contacts the resist film, which causes outdiffusion of the alkaline additives during this bake step within non- or sparsely exposed areas. This outdiffusion leads to a neutralization, or quenching, of acids generated in the resist film during an exposure. Due to the finite diffusion length, the quenching occurs in a region near the contact surface between the resist film and the photosensitive coating.

Unexposed and low exposed regions in the resist film comprise a comparatively low acid concentration such that the quenching will lead to a weaker acidity or even a basicity in that region.

If on the contrary a region of the photosensitive coating is exposed, the photolytic acid generator therein yields the development of an acid concentration during the exposure and the subsequent post-exposure bake may lead to an outdiffusion of these acids from the CCEL into the adjacent resist film and thereby the effect of T-topping is avoided.

Alternatively, a photodecomposable alkaline additive yields a reduction of alkaline concentration in exposed regions of the coating film, and thus alkaline outdiffusion into the underlying resist film is inhibited, or at least reduced.

Referring back to the case of a photolytic acid generator, the ratio of reacting acid generated in the CCEL to that of the alkaline additives is preferably larger than 1 in the intentionally exposed areas, such that the acidity in the resist film is effectively increased. However, a ratio smaller than 1 is also encompassed by the present invention for the sparsely or unexposed areas. As the acidity is increased in the exposed regions, the contrast towards the margin of an exposed region may be considerably enhanced, because beyond this margin the acid concentration has been decreased as explained above due to quenching. Further, the side lobes occurring beyond this margin are also effectively suppressed.

Accordingly, one effect of the invention is that the chemical contrast in acid concentrations between exposed and unexposed regions in the resist is enhanced. As the optical contrast correlates with the contrast in acid concentration, embodiments of the invention work as if the optical contrast had been enhanced. Therefore, according to an embodiment, a photosensitive coating is provided and combined with a further layer of a conventional resist, wherein, e.g., attempts to improve the optical contrast may presently be supported by means of a chemical contrast enhancement.

The photosensitive coating material to be disposed as a contrast enhancing layer may, according to an embodiment, be realized by a base polymer which, according to a preferred embodiment, is based on a polyacrylic acid platform. The polyacrylic acid is soluble in water or in mixtures of isopropanole and water. Water or mixtures of water and isopropanole may be taken as solvents for disposing the photosensitive coating on the wafer. Conventional methods such as spinning may be used to apply the coating to the substrate. In a pre-bake step the solvent is removed from the coating leaving a hardened resist on the substrate. The water-based solvents as described above have the advantage of avoiding undesired intermixing effects between both layers, when a common resist solvent, e.g., Methoxypropylacetate, Ethayllactate, Cyclohexanone, Cyclopentanone, g-Butyrolacton, Ethylacetate, etc., has been used for the under- or overlying resist film.

According to a further embodiment the photolytic acid generator comprises triphenylsulphonium or diphenyliodonium salts of strong sulphonic acids, which are also called Crivello salts. For example, triphenylsulphonium-nonafluorbutanesulphonate or diphenyliodonium-p-toluolsulphonate may be used for the photolytic acid generator. If acids are generated by exposing areas comprising the Crivello salts, a gradient in acidity between alkaline dominated areas and acid dominated areas already within the top coat develops. This gradient is then transferred into the underlying resist by means of diffusion. An additional contrast enhancement at the edges of exposed areas results from this transferral.

The alkaline additive may, according to a further embodiment, be chosen from the class of organic amines. For example trioctylamine or trietanolamine may be used for the alkaline additive.

According to the alternative aspect of a photodecomposable alkaline additive, triphenylsulphonium acetate may be employed to form a photolytic base annihilator. In this case, a photolytic acid generator may be superfluous. In exposed areas the portion of alkaline additives is reduced or neutralized by a base concentration of acids within the top coat, while in sparsely or unexposed areas the alkaline additives are retained and may diffuse into the underlying resist film as explained above. In one embodiment a photodecomposable base may advantageously be combined with a photolytic acid generator.

According to a further embodiment, which relates to both aspects, a photolytic acid generator and/or a photodecomposable base formed within the top coat, the photosensitive coating is arranged to be nearly transparent having an absorption coefficient k of less than 0.05. In this case, the exposure dose is mainly forwarded to the underlying resist (if the photosensitive coating is embodied as a top coating) in order to define exposed regions therein.

According to another embodiment the photosensitive coating is arranged to have a refractive index of less than 1.7 and of more than 1.0 for exposure in gaseous exposure systems. The refractive index then advantageously ranges between that of the underlying resist film and the gas purged through the exposure system thus yielding a reduced reflection at the contact surface between the coating and the resist film.

Therein the transparency may be adjusted by varying the composition of photolytic acid generators and alkaline additives. The refractive index, however, is affected by the specific choice of the polymer and the manner in which the coating is applied to the substrate surface, e.g. spinning or baking.

According to a further embodiment, the photosensitive coating may be selectively developable in the exposed regions with respect to unexposed regions. This means that a development step removes the exposed regions of the photosensitive layer on top of the resist film as well as within the resist film.

Alternatively, the photosensitive coating may be selectively developable, but the (underlying) resist film has to be developed in a second development with respect to the contrast-enhancing photosensitive coating.

In a preferred embodiment, the photosensitive coating is completely developed, be it an exposed or unexposed region. Thereafter, the exposed regions of the resist film are removed in the same or in a further development step.

Another aspect deals with a photosensitive coating applied to a resist film for exposure in a water-based immersion system as the exposure apparatus. Herein, the top coat has to be arranged such that it is not dissolvable with respect to water. The base polymer, therefore, comprises copolymers based on polyvinylalcohole, polymethylmetacrylate, or polyacrylic acid. For example, such a copolymer may be obtained by gradually replacing acid groups of the polyacrylic acid with alcohols thus providing less polarity. When using these copolymers, pure isopropanole is preferred for usage as a solvent.

Further advantageous aspects and embodiments are evident from the appended claims.

### BRIEF DESCRIPTION OF THE DRAWINGS

Other features and many of the attendant advantages of embodiments of the present invention will be readily appreciated and become better understood by reference to the following more detailed description of preferred embodiments in connection with the accompanied drawings. Features that are substantially or functionally equal or similar will be referred to with the same reference signs.

FIG. 1, consisting of FIGS. 1A and 1B, shows different embodiments of a photosensitive coating serving as a contrast-enhancing layer applied to a resist film on a substrate;

FIGS. 2-5 show a sequence of cross-sectional profiles through the photosensitive bi-layer coating shown in FIG. 1A with respect to different method steps according to an embodiment of the invention;

FIGS. 6-9 show the resulting profiles of the base or acid concentration as a function of the x-coordinate corresponding to the profiles shown in FIGS. 2-4;

FIG. 10 shows a profile of base or acid concentration with respect to a second embodiment, wherein the suppression of side lobes is illustrated; and

FIG. 11 shows a third embodiment similar to FIG. 10, wherein different exposure conditions are applied, which conventionally would lead to the occurrence of side lobes.

The following list of reference symbols can be used in conjunction with the figures:
10 substrate
12 layer on substrate, to be structured by lithographic patterning
14 resist film
14′ resist mask
142 bottom resist
144 top resist
16 photosensitive coating, contrast enhancing layer (CEL)
18 surface region in resist film, available for diffusion
22 exposed region in CEL
24 unexposed region in CEL
32 exposed region in resist film
34 unexposed region in resist film
40 exposure light beam
50 etch step

### DETAILED DESCRIPTION OF ILLUSTRATIVE EMBODIMENTS

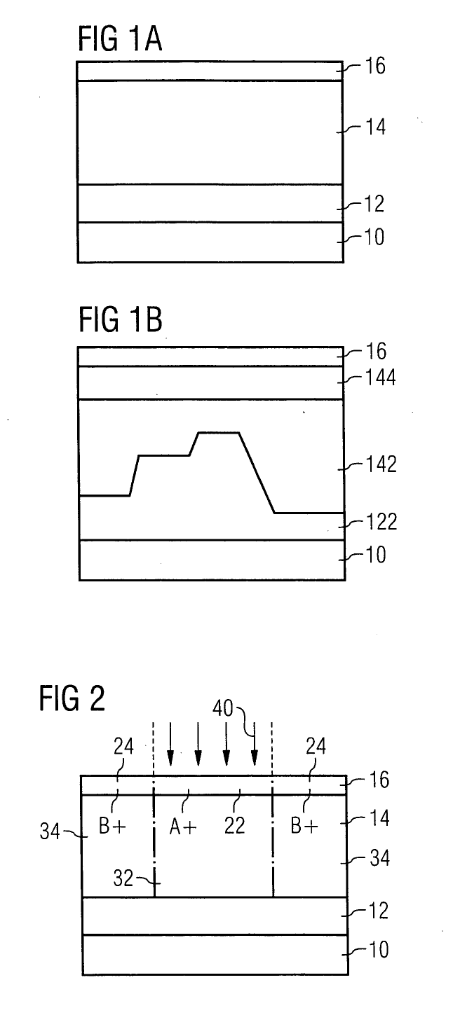

In FIG. 1 different embodiments of a photosensitive coating serving as a contrast-enhancing layer are shown. FIG. 1A shows a case wherein a layer 12 of a material to be structured (etched) such as an oxide, a nitride, a metal, polysilicon, etc., is deposited on a substrate 10, which may refer to monocrystalline silicon. A resist film 14 is spun on the layer 12. The resist film 14 is formed of any conventionally known type of resist material, e.g., positive or negative, Novolak-based, chemically amplified, etc.

Further, a photosensitive coating 16 is applied upon the resist film 14. This coating 16 comprises a water-soluble base polymer, e.g., a polyacrylic acid, a photolytic acid generator, e.g., a Triphenylsulphonium salt, and an alkaline additive, e.g., Trioctylamine. In order to deposit the coating 16 upon the resist film 14, the ingredients as described above are dissolved in a solvent, which is a mixture of water and isopropanole according to this embodiment. This coating material is spun on the substrate 10 including layer 12 covered with the resist film 14. A pre-bake step is performed to dry the still semi-liquid coating material.

The resist material comprises a base polymer considered to be soluble with respect to Methoxypropylacetate, Ethayllactate, Cyclohexanone, Cyclopentanone, g-Butyrolacton, Ethylacetate, etc., such that it may not be dissolved by the top coating 16 of the contrast enhancing layer. The top coating 16 has a thickness in the range 30-250 nm, while the resist film 14 has a thickness of 50 to 400 nm.

FIG. 1B shows a second embodiment with a photosensitive coating 16 disposed on a first resist film 144. This resist film is part of a bi-layer resist, wherein this upper layer refers to a top resist, which is a chemically amplified resist (CAR). A second bottom resist 142 merely serves to compensate a surface topography due to one or more layers 122 to be structured by means of an etch applied to the substrate using the developed resist as a mask.

FIGS. 2-5 illustrate a method of processing the resist according to embodiments of the invention, which starts from the situation as displayed in FIG. 1A. With regard to FIG. 2, an exposure light beam 40 having a wavelength of, e.g., 193 nm (DUV, deep ultraviolet) impinges on the photosensitive coating to form an exposed region 22 therein, further leaving regions 24 unexposed. The exposure light beam 40 may be generated by means of a mask or reticle arranged within the optical path of light in a corresponding exposure tool.

As the photosensitive coating 16 has an absorption coefficient k of less than 0.05 and a thickness of less than 100 nm, the coating is nearly transparent and the beam 40 reaches into the resist film 14 forming an exposed region 32 therein. The resist also comprises a base polymer and photolytic acid generators, however, the resist film 14 lacks a base additive when compared with the top coating 16.

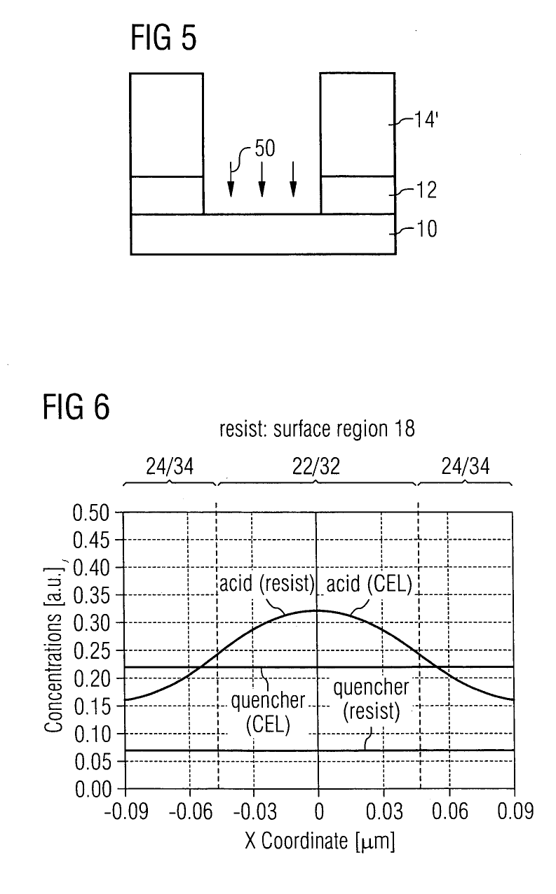

Alkaline molecules (quenchers, indicated by “B+” in the figures) are initially present over the whole surface area of the top coating 16, but are neutralized by the acids currently generated in the exposed region 22, as indicated by an “A+”. Accordingly, the exposed region 22 is mainly acid while the unexposed regions 24 are mainly alkaline. The resulting concentrations (in arbitrary units) are schematically depicted in FIG. 6 as a function of x-coordinate.

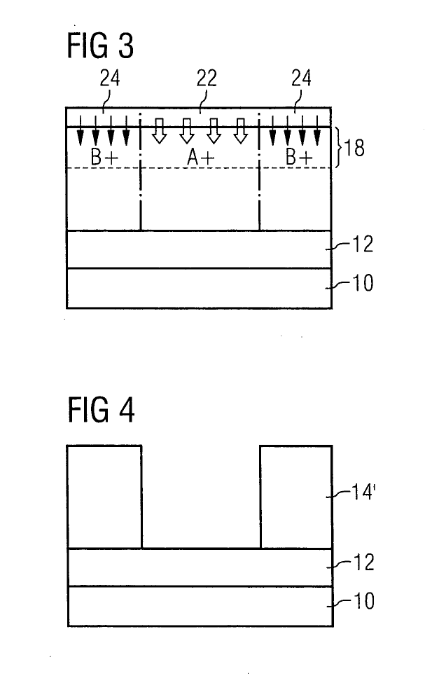

FIG. 3 shows further development of the process during performance of a post-exposure bake. The temperature applied provokes outdiffusion of the acids and alkaline molecules (quenchers) into the adjacent resist film, respectively. The diffusion length is limited such that only a surface region 18 of the resist film 14 is affected by diffusion. Loss of acids generated in the resist film 14 may also occur by means of diffusion into the top coating 16. It is further noted that the individual diffusion lengths of the acids and the quenchers may be different such that vertical concentration profiles may follow.

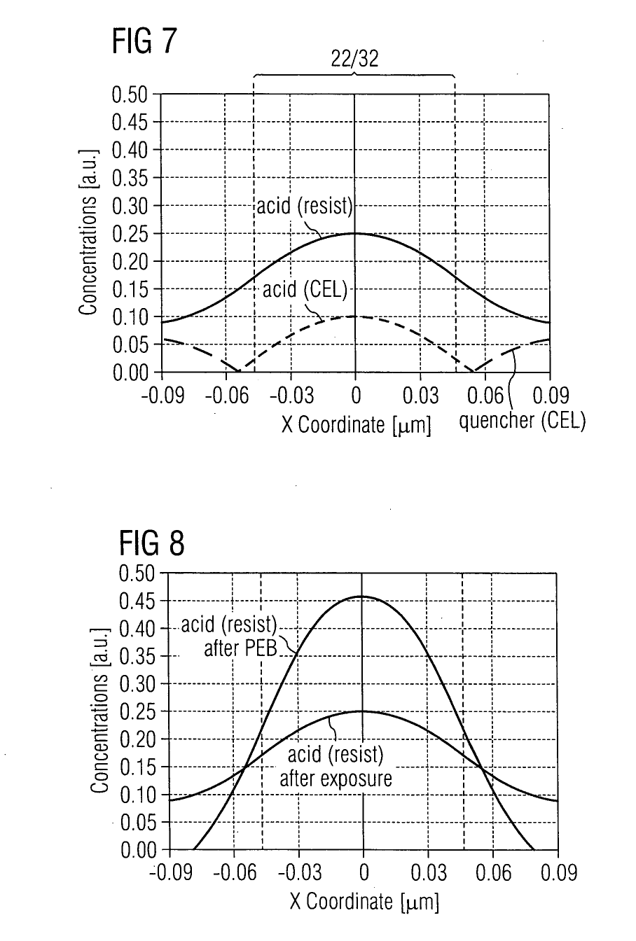

As a result of the diffusion, the quencher concentration B+ in the unexposed region 34 in the resist film increases and the minor acid concentration is neutralized. On the contrary, the acid concentration A+ in the exposed region 32 of the resist film 14 increases, which is shown in the diagrams of FIGS. 7 and 8. FIG. 7 shows an imaginary step according to this simplified embodiment, wherein the acid concentration profile in the resist film 14 has been reduced by the concentration of quenchers already present within the resist surface region 18. The dashed curves show the remaining concentrations of acids and quenchers within the photosensitive coating 16, denoted “CEL” in FIGS. 6-11.

FIG. 8 shows the result after the diffusion step, i.e., adding the acid concentrations (exposure region 32) and subtracting quencher concentrations from acid concentrations (unexposed regions 34). It is clearly visible that the concentration profile of acids in the resist is steepened, or the contrast is enhanced.

Returning to the process of lithographically structuring the substrate, FIG. 4 displays the situation after the photosensitive coating 16 (exposed and unexposed regions) and the resist film 14 (exposed region only) have been developed using, e.g., a conventional TMAH developer: 2.38% Tetramethylammoniumhydroxide (TMAH) dissolved in water and additives. Unexposed portions of the resist remain as a resist mask 14′. An etch process 50 may then be performed to transfer the exposed structure from the resist (resist mask 14′) into the layer 12.

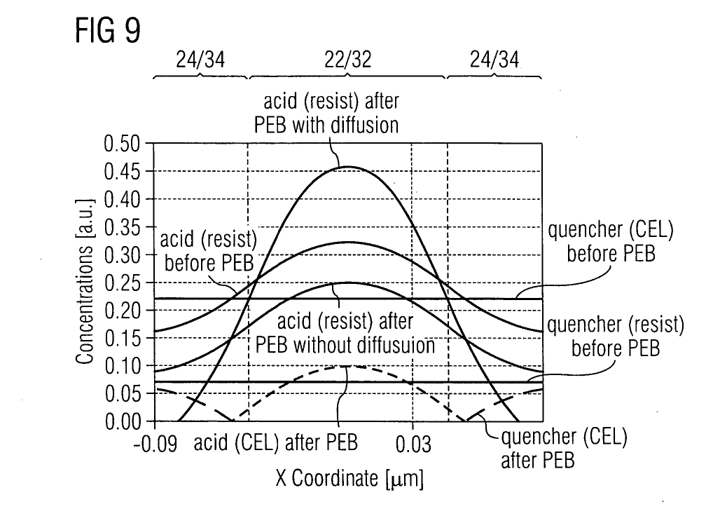

FIG. 9 provides an overview of the concentrations of acids and quenchers achieved in the individual steps displayed in the foregoing. The concentration profiles relate to an exposure of a wafer using a halftone mask with 6% attenuation, comprising a 90 nm lines and spaces pattern (widths refer to wafer scale). The numerical aperture was 0.75, illumination was carried out with annular σ=0.55-0.85. A bottom antireflective coating was further used.

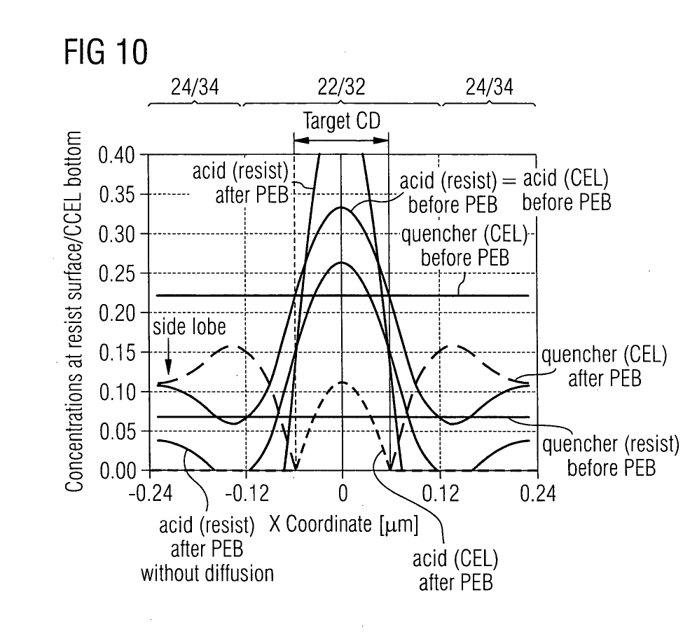

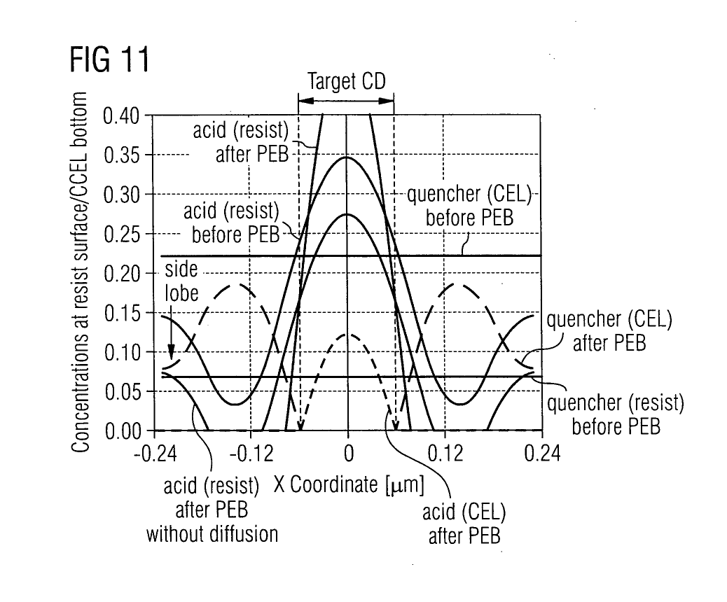

FIG. 10 shows for comparison a more challenging exposure condition, that illustrates the development of side lobes in the surface region 18 of the resist near the primarily exposed region 32. The illumination was circular with σ=0.5 while the other parameters were the same as in the example given above. It is clearly visible, that the occurrence of the side lobe extending at a distance of 150 to 180 nm from the main structure (“target”) is mitigated by means of a reduced acid concentration at that position.

FIG. 11 shows an even more challenging exposure condition with an illumination σ=0.2, which may yield the occurrence of a side lobe in the resist effectively after a following development step. Applying the photosensitive coating 16 as a contrast enhancing layer according to this embodiment of the invention, the side lobe is similarly mitigated as in the previous example.

Although the present invention and its advantages have been described in detail, it should be understood that various changes, substitutions and alterations can be made herein without departing from the spirit and scope of the invention as defined by the appended claims.

What is claimed is:

1. A photosensitive coating material for enhancing a contrast of a photolithographic exposure of a resist film formed on a substrate, the photosensitive coating material comprising:
a base polymer;
a solvent for facilitating deposition of the photosensitive coating material upon a surface adjacent to said resist to form a film thereupon;
an alkaline additive suited to diffuse into the adjacent resist for reducing or neutralizing an acid concentration formed locally therein; and
a photoactive component arranged to reduce or neutralize a concentration of the alkaline additives in portions of the photosensitive coating that are exposed with optical light, UV radiation, X-ray radiation, electrons, charged particles, or ion projection lithography.

2. The photosensitive coating according to claim 1, wherein
the photoactive component is a photolytic acid generator for releasing an acid under said exposure, said acid being suited to diffuse into the adjacent resist for enhancing an acid concentration formed locally therein.

3. The photosensitive coating according to claim 2, wherein the photoactive component is provided by the alkaline additive, which is photodecomposable, wherein the alkaline additive is arranged to decompose to a non-alkaline, neutral compound within said portions of the photosensitive coating, which are exposed with optical light, UV radiation, X-ray radiation, electrons, charged particles, or ion projection lithography.

4. The photosensitive coating according to claim 3, wherein the alkaline additive contains Triphenylsulphonium acetate.

5. The photosensitive coating according to claim 1, wherein the base polymer is soluble with respect to the solvent, which comprises water, for enabling an exposure in dry, air-based exposure systems.

6. The photosensitive coating according to claim 1, wherein the base polymer is soluble with respect to a developer comprising Tetramethylammoniumhydroxide (TMAH) dissolved in water and additives, prior to and after an exposure of the coating material with optical light, UV or X-ray radiation or a particle beam.

7. The photosensitive coating according to claim 1, wherein the base polymer is soluble with respect to the solvent, which comprises a mixture of water and isopropanole, for enabling an exposure in an immersion-based exposure system.

8. The photosensitive coating according to claim 1, wherein the base polymer comprises carboxylic acid groups.

9. The photosensitive coating according to claim 1, wherein the base polymer comprises alcoholic functions.

10. The photosensitive coating according to claim 2, wherein the photolytic acid generator comprises a Crivello salt, ortho-Nitro-benzylcompounds, AsF₆ or SbF₆, Phthalimidotosylates or related sulphonic nitrogen bound esters of Phthalimides.

11. The photosensitive coating according to claim 10, wherein the Crivello salt is one of Triphenylsulphonium- or Diphenyliodonium-sulphonates.

12. The photosensitive coating according to claim 2, wherein the photolytic acid generator comprises Triphenylsulphonium-nonafluorbutanesulphonate.

13. The photosensitive coating according to claim 2, wherein the photolytic acid generator comprises Diphenyliodonium-p-Toluolsulphonate.

14. The photosensitive coating according to claim 1, wherein the alkaline additive is an organic amine.

15. The photosensitive coating according to claim 14, wherein the alkaline additive is at least one of Trialkylamine or Trialcohol amines.

16. The photosensitive coating according to claim 15, wherein the alkaline additive is a Trioctylamine or a Triethanolamine.

17. The photosensitive coating according to claim 1, wherein a composition of the base polymer, the photoactive component and the alkaline additive is arranged, such that the photosensitive coating is transparent to an incident light or particle beam having an absorption coefficient of less than 0.05, when the solvent is removed in a bake step.

18. The photosensitive coating according to claim 1, wherein a composition of the base polymer, the photoactive component and the alkaline additive is arranged such that the photosensitive coating has a refractive index of more than or equal to 1.0 and of less than or equal to 1.7.

19. The photosensitive coating according to claim 1, wherein a composition of the base polymer, the photoactive component and the alkaline additive is arranged such that portions of the photosensitive coating being exposed are selectively removable with respect to a TMAH developer solution.

20. The photosensitive coating according to claim 1, wherein a composition of the base polymer, the photoactive and the alkaline additive is arranged such that the photosensitive coating is completely removable with respect to a TMAH developer solution.

21. A multilayer coating disposed on a substrate prior to photolithographic exposure, the coating comprising:
at least one photosensitive resist film; and
a contrast enhancing layer (CEL), which is deposited upon said photosensitive resist film, the contrast enhancing layer comprising:
(a) a base polymer;
(b) an alkaline additive suited to diffuse into the resist film for locally reducing or neutralizing an acid concentration formed therein; and
(c) a photoactive component arranged to reduce or neutralize a concentration of the alkaline additives in portions of the photosensitive coating, which are exposed with said optical light, UV radiation, X-ray radiation, electrons, charged particles, or ion projection lithography.

22. The multilayer coating according to claim 21, wherein said the photoactive component of the contrast enhancing layer comprises a photolytic acid generator for releasing an acid under said exposure, said acid being suited to diffuse into the adjacent resist film for enhancing an acid concentration formed locally therein.

23. The multilayer coating according to claim 21, wherein the photoactive component of the contrast enhancing layer is provided by the alkaline additive, which is photodecomposable, wherein the alkaline additive is arranged to decompose to a non-alkaline, neutral compound within said portions of the contrast enhancing layer under said exposure.

24. The multilayer coating according to claim 21, wherein the photosensitive resist film is a chemically amplified resist film.

25. The multilayer coating according to claim 21, further comprising a bottom resist film for compensating height differences of a surface topography of the substrate, said bottom resist film being disposed on the substrate below the chemically amplified resist film.

26. The multilayer coating according to claim 21, wherein the base polymer is soluble with respect to a solvent, which comprises water, for enabling an exposure in dry, air-based exposure systems.

27. The multilayer coating according to claim 21, wherein the base polymer is soluble with respect to a developer comprising Tetramethylammoniumhydroxide (TMAH) dissolved in water and additives, prior to and after an exposure of the contrast enhancing layer with optical light, UV radiation, X-ray radiation, electrons, charged particles, or ion projection lithography.

28. The multilayer coating according to claim 21, wherein the base polymer is soluble with respect to a solvent, which comprises a mixture of water and isopropanole, for enabling an exposure in an immersion-based exposure system.

29. The multilayer coating according to claim 21, wherein the base polymer comprises carboxylic acid groups.

30. The multilayer coating according to claim 21, wherein the base polymer comprises alcoholic functions.

31. The multilayer coating according to claim 21, wherein the photolytic acid generator comprises a Crivello salt, ortho-Nitro-benzylcompounds, AsF₆ or SbF₆, Phthalimidotosylates or related sulphonic nitrogen bound esters of Phthalimides.

32. The multilayer coating according to claim 31, wherein the Crivello salt is one of Triphenylsulphonium- or Diphenyliodonium-sulphonates.

33. The multilayer coating according to claim 21, wherein the photolytic acid generator comprises Triphenylsulphonium-nonafluorbutanesulphonate.

34. The multilayer coating according to claim 21, wherein the photolytic acid generator comprises Diphenyliodonium-p-Toluolsulphonate.

35. The multilayer coating according to claim 21, wherein the alkaline additive comprises an organic amine.

36. The multilayer coating according to claim 21, wherein the alkaline additive comprises at least one of Trialkylamine or Trialcohol amines.

37. The multilayer coating according to claim 36, wherein the alkaline additive comprises a Trioctylamine or a Triethanolamine.

38. The multilayer coating according to claim 21 in combination with said substrate, wherein the multiplayer coating is disposed on a surface of the substrate.

39. The multilayer coating according to claim 38, wherein said substrate comprises a photomask.

40. The multilayer coating according to claim 38, wherein said substrate comprises a semiconductor wafer.

41. The multilayer coating according to claim 38, wherein the surface is provided by a material layer, which is deposited on said substrate.

42. A method of manufacturing a photosensitive coating material for enhancing the contrast of a photolithographic exposure of a photosensitive resist film, wherein the photosensitive coating material is to be deposited on top of the photosensitive resist film, the method comprising:
providing a coating material that includes:
a base polymer;
a photoactive component arranged to reduce or neutralize a concentration of the alkaline additives in portions of the photosensitive coating, which are exposed with optical light, UV radiation, X-ray radiation, electrons, charged particles, or ion projection lithography;
an alkaline additive suited to diffuse into an adjacently arranged resist for reducing or neutralizing an acid concentration formed locally therein; and
dissolving the base polymer, the photoactive component and the alkaline additive in a solvent for facilitating deposition of the photosensitive coating material upon a surface adjacent to the resist to form a film thereupon.

43. The method according to claim 42, wherein the step of providing the photoactive component includes providing a photolytic acid generator for releasing an acid under said exposure, said acid suited to diffuse into the adjacent resist for enhancing an acid concentration formed locally therein.

44. The method according to claim 42, wherein the step of providing the photoactive component includes providing a photodecomposable alkaline additive, wherein the alkaline additive is arranged to decompose to a non-alkaline, neutral compound within said portions of the photosensitive coating, which are exposed with optical light, UV radiation, X-ray radiation, electrons, charged particles, or ion projection lithography.

45. The method according to claim 42, wherein the step of providing the base polymer includes providing a water-soluble base polymer for enabling an exposure in dry, air-based exposure systems.

46. The method according to claim 42, wherein the step of providing the base polymer includes providing a base polymer that is soluble with respect to a developer comprising Tetramethylammoniumhydroxide (TMAH) dissolved in water and additives.

47. The method according to claim 42, wherein the step of providing the base polymer includes providing a base polymer that is soluble with respect to a solvent, which is based on a mixture of water and isopropanole, for enabling an exposure in an immersion-based exposure system.

48. The method according to claim 42, wherein the step of providing the base polymer comprises providing a base polymer having carboxylic acid groups.

49. The method according to claim 42, wherein the step of providing a base polymer comprises providing a base polymer having alcoholic functions.

50. The method according to claim 43, wherein the step of providing photolytic acid generator comprises providing a photolytic acid generator, which is a Crivello salt, ortho-Nitro-benzylcompounds, AsF₆ or SbF₆, Phthalimidotosylates or related sulphonic nitrogen bound esters of Phthalimides.

51. The method according to claim 42, wherein the step of providing the alkaline additive includes providing organic amines.

52. A method of exposing a semiconductor wafer, the method comprising:
applying a photosensitive resist to the surface of the semiconductor wafer to form a resist film, the resist file comprising:
a first base polymer and a first photolytic acid generator;
applying a photosensitive coating material to said semiconductor wafer to form a contrast enhancing layer (CEL) upon the resist, said contrast enhancing layer comprising a second base polymer, an alkaline additive and a photoactive component;
exposing said contrast enhancing layer and the underlying resist film within a portion with optical light, UV radiation, X-ray radiation, electrons, charged particles, or ion projection lithography, wherein:
a concentration of the alkaline additives in exposed portions of the contrast enhancing layer is reduced or neutralized due the exposure of the photoactive component, and
a concentration of acids in exposed portions of the resist film is increased due to the exposure of the first photolytic acid generator;
diffusing the alkaline additive remaining in unexposed portions of the contrast enhancing layer into a surface region of the adjacent resist film to decrease or neutralize an acid concentration in unexposed portions of the resist film and to increase the contrast in acid concentration between exposed and unexposed portions therein; and
developing the resist film to remove either exposed or unexposed portion thereof.

53. The method according to claim 52, wherein the step of diffusing the alkaline additive into the resist film is performed by means of a post exposure bake step.

54. The method according to claim 52, further comprising both exposed and unexposed portions the contrast enhancing layer by means of a further development, wherein the further development of the coating film is performed selectively with respect to the underlying resist film.

55. The method according to claim 52, wherein applying the photosensitive coating film comprises providing a photolytic acid generator as the photoactive component, and wherein diffusing the remaining alkaline additives into the resist film includes diffusing acids generated by the photolytic generator within exposed regions of the contrast enhancing layer into exposed portions of the resist film in order to increase the acid concentration therein.

56. The method according to claim 52, wherein applying the photosensitive coating comprises providing the alkaline additive simultaneously as the photoactive component, and wherein exposing the coating film includes decomposing the alkaline additive to a non-alkaline, neutral compound within the exposed portions of the photosensitive coating in order to reduce or neutralize the concentration of alkaline additives formed therein.
